(19) United States
(12) Patent Application Publication
(10) Pub. No.: US 2006/0219108 A1
(43) Pub. Date: Oct. 5, 2006

(54) Apparatus and method for production of personalized gift-wrap

(76) Inventors: Cheryl B. Dorrell, Alpharetta, GA (US); Thomas H. Fitzgerald, Douglasville, GA (US); Bernard M. Bryan, Las Vegas, NV (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/395,913

(22) Filed: Mar. 31, 2006

Related U.S. Application Data
(60) Provisional application No. 60/667,531, filed on Apr. 1, 2005.

(51) Int. Cl. B41F 5/18

(52) U.S. Cl. 101/178

(57) ABSTRACT

Personalized gift-wrap, fabricated from a wide, coated, decorative paper roll-stock, and having a personalized message imprinted thereon, is disclosed; as well as methods and apparatus for production thereof.

### CROSS-REFERENCE TO RELATED APPLICATION

This application claims the benefit of U.S. Provisional Patent Application Ser. No. 60/667,531, filed Apr. 1, 2005, which is hereby incorporated herein by reference in its entirety for all purposes.

### TECHNICAL FIELD

The present invention relates generally to paper used for wrapping gifts or for other purposes, and more particularly to such paper imprinted with a personalized message, and to an apparatus and method for producing personalized paper goods such as for use as gift-wrap.

### BACKGROUND OF THE INVENTION

It is common to wrap gifts in paper, or gift wrap, for decorative and/or protective purposes. Typically, gift-wrap is a coated paper product, often having a decorative pattern or coloration provided on at least one side. Gift-wrap is typically produced in wide (generally about 24″, 30″-31″, or 36″ wide) roll stock. However, gift-wrap can be produced in various sizes including narrower roll stock (such as 8″ wide).

Often, persons giving a gift may wish to personalize the gift. For example, the persons giving a gift may wish to identify the recipient, to provide recognition of an event, etc. Traditionally, this might be done by attaching tags bearing a message, or specially colored ribbons or the like, to a wrapped gift. It is also known to imprint narrow ribbon stock with a message, including a personalized message. Such traditional modes of personalization of gifts have met with varying degrees of acceptance in the marketplace.

Unfortunately, those persons wishing to personalize the paper used to wrap gifts currently have very limited options to do so. For instance, a person giving a gift may use a marker, crayon, or paint to hand-write a personalized message on gift-wrap paper, or may use a computer printer to print a message on a sheet of non-gift-wrap paper. Alternatively, a person may use stickers or decals in an effort to personalize the paper. However, it is typically very difficult and time consuming to personalize the paper, especially if the person giving the gift wishes for the personalized paper to have a “professional” quality.

Accordingly, it can be seen that needs have been recognized for continuing development in this field of endeavor. Thus it can be seen that needs exist for improvements to paper goods, including those utilized as gift-wrap, and to methods and apparatus for carrying out such improvements. It is to a provision of these needs and others, that the current invention is directed.

### SUMMARY OF THE INVENTION

The present invention is directed to improvements in personalization of gift-wrap and similar products, and to methods and apparatus for carrying out those improvements. In an example form, one aspect of the present invention is a wide, coated gift-wrap paper stock, which is imprinted with a personalized message. Such a personalized message can be of many forms including an individual's name, a symbol or design, or a message such as “Happy Birthday” or “Merry Christmas”. In such a form, persons wishing to wrap a gift have the opportunity to personalize the gift with high quality/professional appearing imprinted gift-wrap without spending an inordinate amount of time in personally decorating the gift-wrap.

In another aspect, the invention is a printing apparatus having a first drive mechanism for transporting wide paper stock in a first direction, a second drive mechanism for transporting printing foil over the paper stock in a second direction, for example generally transversely or obliquely oriented relative to the first direction, and a printing head for impression of the printing foil against the paper stock to print a personalized message onto the paper stock. In a particular embodiment, a single drive motor powers both the first and second drive mechanisms and the print head.

In still another aspect, the invention is a method of personalizing gift-wrap, including installing an interchangeable print slug into a print head of a printing apparatus. The interchangeable print slug includes an impression face in the pattern of a message. The message can have a particular significance to an individual. The print head is operated to print the message having a particular significance to an individual onto paper stock suitable for gift-wrapping.

In another aspect, the invention is a method of printing a personalized message onto paper stock suitable for use as gift-wrap. In a particular embodiment, the gift-wrap includes two or more, and preferably three or more, lines of text, with each line staggered or offset from adjacent lines.

In still another aspect, the invention is an apparatus for printing personalized gift-wrap. The apparatus includes an electric motor, a print head actuated by the electric motor, a paper stock advancement mechanism driven by the electric motor, and a printing foil advancement mechanism driven by the electric motor. The print head further includes at least one receiver chase for releasably engaging an interchangeable printing slug for printing a personalized message. The paper stock advancement mechanism and the foil advancement mechanism advance both the paper stock and the foil, respectively, in step-wise increments in sequence with the motion of the print head.

In another aspect, the invention is a personalized gift-wrap product including a paper stock suitable for use as gift wrapping and a message transfer-printed onto said paper stock. The message can have a particular significance to an individual.

In another aspect, the invention is a printing apparatus having a first drive mechanism for transporting wrapping paper stock in a first direction, and a second drive mechanism for transporting printing media over the paper stock. Additionally, the invention includes a printing head for transferring a portion of the printing media onto the paper stock in the pattern of a personalized message.

In yet another aspect, the invention is a personalized gift-wrap product including a paper stock suitable for use as gift wrapping and a message transfer-printed onto the paper. The message can have a particular significance to an individual.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a top view of an apparatus for personalization of gift-wrap, according to an example form of the present invention.

FIG. 2 is a perspective view of the apparatus of FIG. 1.

FIG. 3 is a perspective view of the apparatus of FIG. 1 shown with the printing face of the print head inverted.

FIG. 4 is a perspective view of a chase for securing printing slugs to the face of the print head shown in FIG. 3.

FIG. 5 is an internal close-up front view of a portion of the apparatus of FIG. 1, showing an electric motor, gear box, cam shaft, and cam.

FIG. 6 is an internal close-up perspective view of a portion of the apparatus of FIG. 1, showing the electric motor, gear box, cam shaft, and belt drive.

FIG. 7 is an internal close-up front view of a portion of the apparatus of FIG. 1, showing the electric motor, gear box, cam shaft, cam, and belt drive.

FIG. 8 is a close-up perspective view of a portion of the apparatus of FIG. 1, showing example print head pressure adjustment mechanisms.

FIG. 9 is a perspective view of a portion of the apparatus of FIG. 1, showing the foil advancement mechanism.

FIG. 10 is a perspective view of a portion of the apparatus of FIG. 1, showing the foil advancement mechanism in greater detail.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

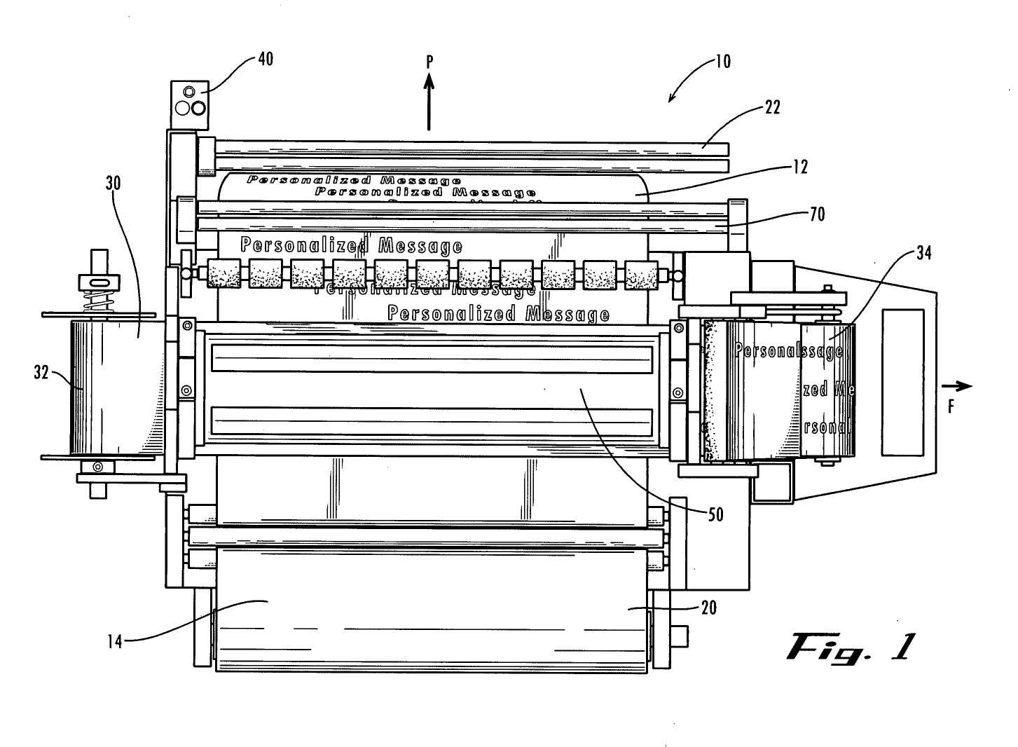

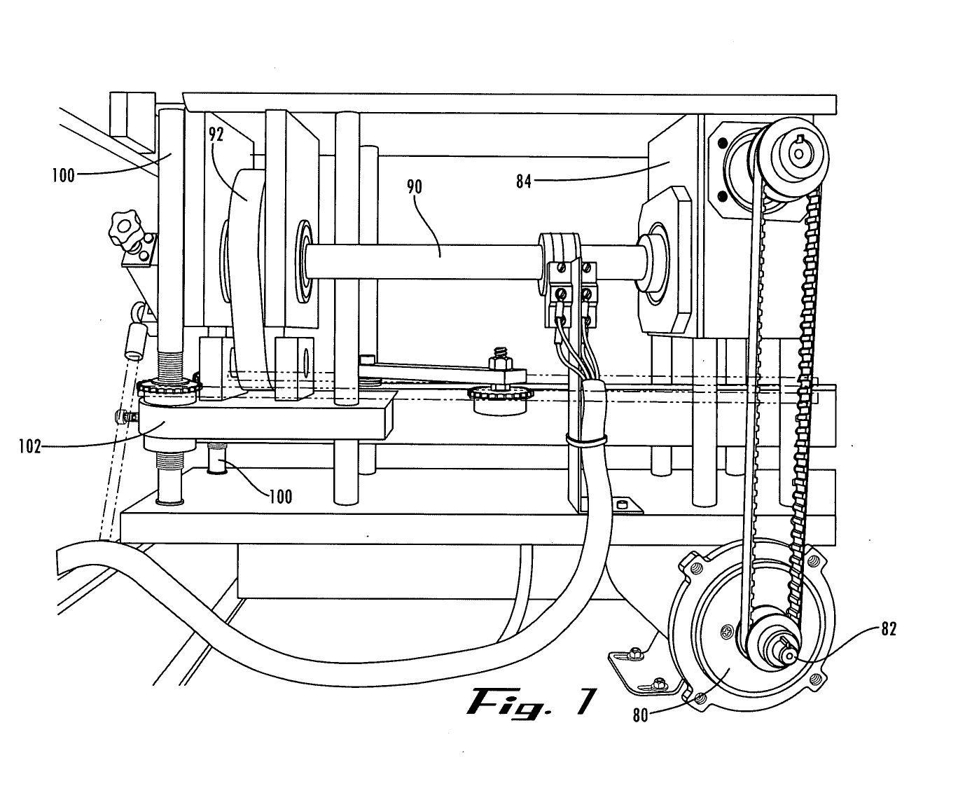

With reference now to the drawing figures, FIGS. 1-10 show an example embodiment of an apparatus 10 for producing personalized gift-wrap 12 according to the present invention. Paper stock 14 (preferably about 7.5″, 15″, 24″, 30″-31″, or 36″ wide), preferably of a coated type suitable for use as gift-wrap, moves along a path through the apparatus 10 in a first direction, indicated by direction arrow P, from a feed roll 20 to a take-up roll 22 as best seen in FIG. 1. A cardboard tube is preferably installed on the take-up rollers 22, and the leading edge of the printed paper is taped thereto so that the paper is rolled onto the cardboard core to form a roll of personalized gift-wrap paper. A quick-release or easy-release hot-stamping printing foil 30, for example 4½″ roll width, moves along a path through the apparatus 10 in a second direction F generally crosswise or transverse to the path of paper 14 travel, from a feed roll 32 to a take-up roll 34. In alternate embodiments, the path of the foil 20 is oblique or parallel to the paper path 14.

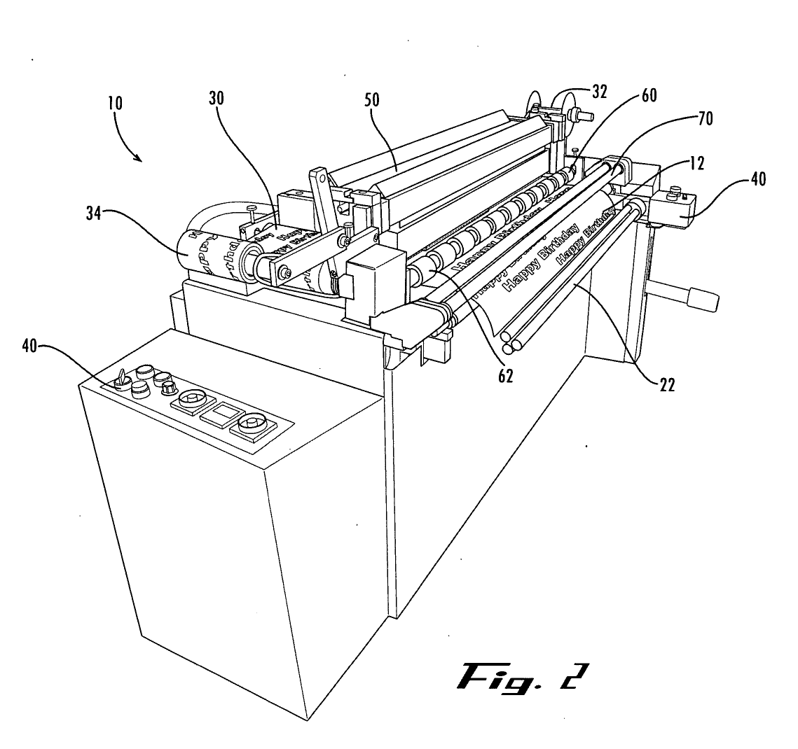

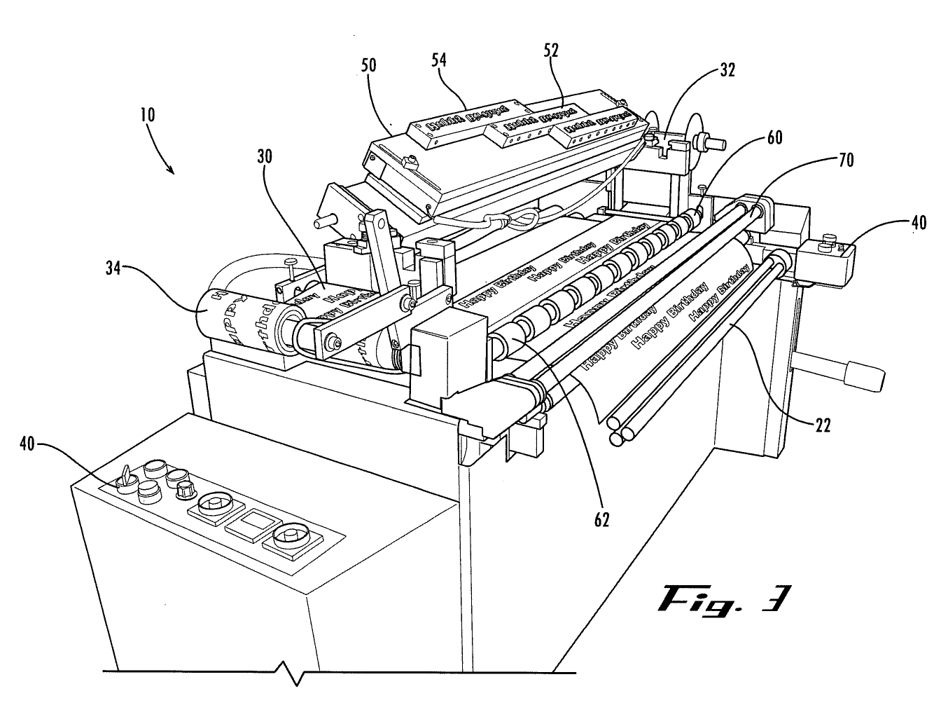

As shown in FIGS. 2-3, one or more substantially rigid, heated printing heads 50 are operable to be repeatedly raised and lowered to emboss the printing foil 30 onto the paper stock 14, as in letter-press printing operations. Each print head 50, for example, preferably comprises a 110V, 12″ print-head heater. The paper stock 14 and foil 30 are advanced through step-wise increments each time the printing head 50 is raised between subsequent printing cycles. The paper stock 14 is advanced by at least one paper stock advancement assembly 60 that can include a plurality of rollers 62 that engage and laterally advance the imprinted gift-wrap 12 away from the printing head. Then as the printing head 50 is lowered, advancement of the paper 14 and foil 30 stops. In its lowered position, the printing head 50 presses one or more heated printing slugs 52 mounted to the print head(s) against the foil 30 and onto the paper 14, thereby transfer-printing the foil to adhere onto the paper in a pattern corresponding to that of the slugs' impression faces.

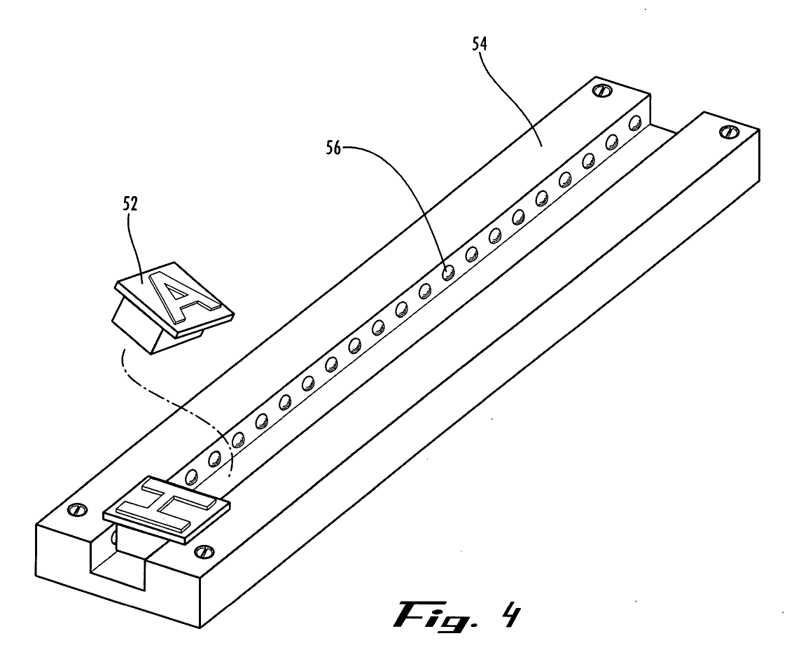

In an example embodiment, the print head 50 includes two or more chases 54 for removably holding interchangeable printing slugs 52, comprising at least one and preferably a plurality of letters, preferably formed into one or more words, for embossing printed messages onto the paper stock, as depicted in FIG. 4. In other example embodiments, the printing slugs 52 may comprise symbols, shapes, or designs such as balloons, logos, etc. In a preferred form, the chases 54 are equipped with one or more spring biased bearings 56 to engage and secure the slugs 52 within the chase in the position desired by a user. The spring-biased engagement bearings enable a user to quickly interchange slugs 52 by lifting the slugs out of the chase 54 and pressing a replacement slug into engagement with the spring biased bearings 56 within the chase.

The slugs 52 can be replaced as often as desired by a user, and are preferably personalized to print any desired message onto the paper stock 14 to produce personalized gift-wrap 12, for example in quantities as small as one roll or less. In example embodiments, three or more chases 54 are preferably provided in the printing head 50 as shown in FIG. 3. Each chase 54 is preferably adapted to receive at least one removable slug 52, and the slugs are preferably positioned in the print head in a staggered array, with each slug laterally offset relative to adjacent slugs. Each slug 52 in the array preferably includes identical lettering to print the same personalized textual message in offset rows on the paper stock 14, such that if a portion of the paper's width is trimmed off during the gift wrapping process, at least some of the rows of text will remain legible. In other forms, the slugs 52 are laterally aligned and/or the lettering can be inconsistent throughout the array, such that each slug imprints a different message on the paper stock 14.

A manual or automated paper cutting bar 70 is optionally provided for cutting the imprinted personalized gift-wrap 12 when a desired length of product has been collected on the take-up roll 22, as shown in FIGS. 1-3. In example forms, a rotary cutting blade (not shown) is affixed to the cutting bar 70 enabling a user to slide the blade along the length of the bar, thereby cutting the imprinted personalized gift-wrap 12 to length. In other example forms, alternate types of cutting implements are used to cut the gift-wrap 12 such as knife blades, scissors, etc. In another embodiment, the apparatus of the invention includes one or more width-cutting blades that can be selectively engaged or disengaged against a collected roll of personalized gift-wrap 12 on the take-up roll 22, to permit a single wide roll to be cut into multiple narrower rolls. For example, a singe 24″ wide roll of personalized gift-wrap may be cut into three 8″ wide rolls. In this embodiment, the print head assembly optionally includes separate chases for printing personalized messages on each of the narrower rolls, and utilizes a smaller type size. In order to allow a longer message to be printed on the narrower rolls, the chase(s) of the print head are optionally angled obliquely relative to the length of the print head.

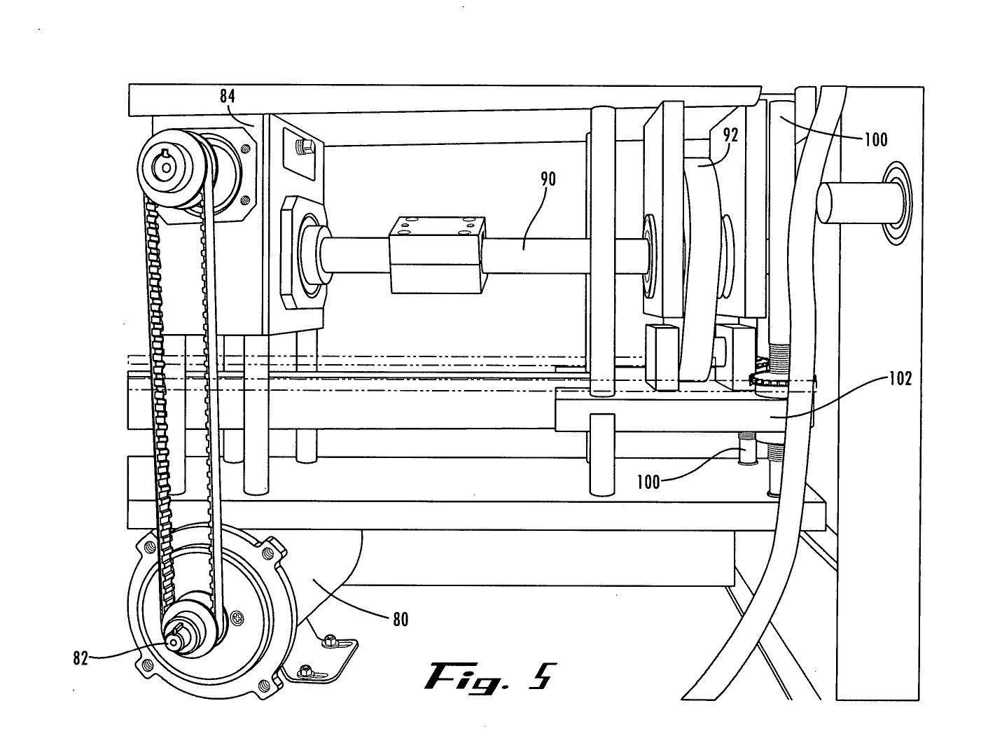

Referring now to FIGS. 5-10, chain or belt drive mechanisms, gearing, and/or other transmission means are preferably provided to transmit drive power from one or more drive motors to operate the print head assembly 50 and advance both the paper stock 14 and the printing foil 30. In a preferred embodiment, a single electric motor 80 powers the drive mechanisms for both the paper stock advancement 60 and the printing foil advancement mechanism. One or more control panel(s) 40 is/are preferably provided, to receive user input and/or display process output (as best seen in FIGS. 1-3). Mechanical indexing mechanisms and/or electronic control circuitry is/are preferably linked to the drive mechanisms for the paper stock 14 and the printing foil 30, to sequentially index or step the paper and foil along their respective paths between printing cycles.

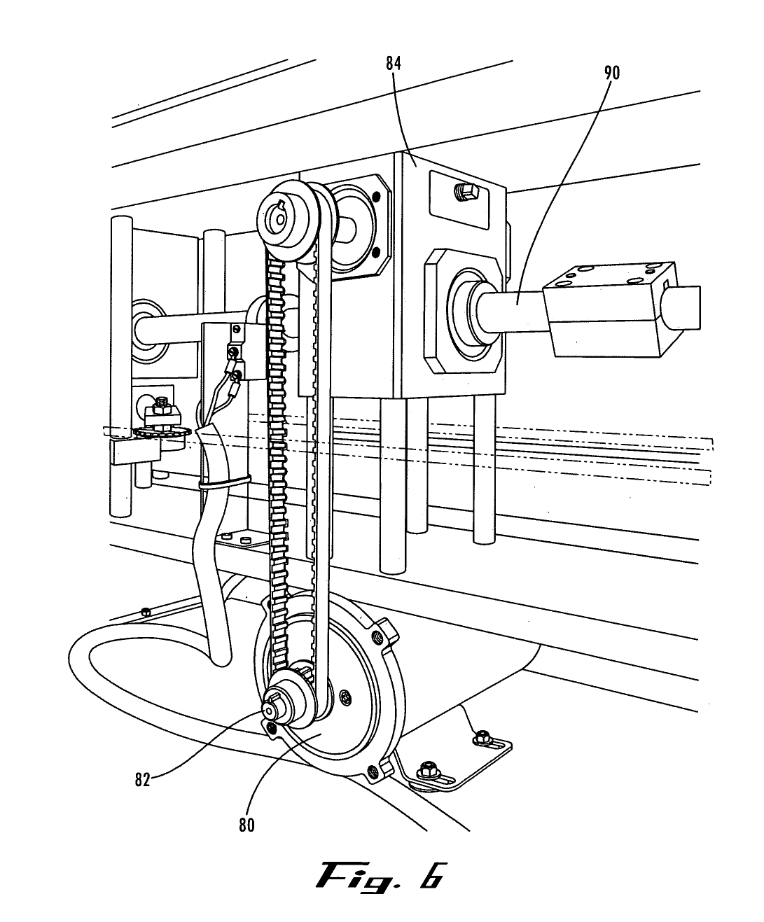

For instance, in example embodiments a horizontal output shaft 82 of the electric motor 80 is belt-linked with a single gear box 84, which transfers power to a horizontal transverse cam shaft 90 as seen in FIGS. 5-6. The cam shaft 90 preferably has at least two cams 92 coupled thereto, which when rotated, raise and lower the print head assembly 50. The print head assembly 50 is preferably carried on by at least four vertical posts 100 and at least two sub-platforms 102, wherein each platform is adjustably coupled to at least two vertical posts. Each sub-platform 102 is also rotatably coupled to one of the cams 92, such that interaction with the cam raises and lowers the platforms, the vertical posts 100, and the print head 50.

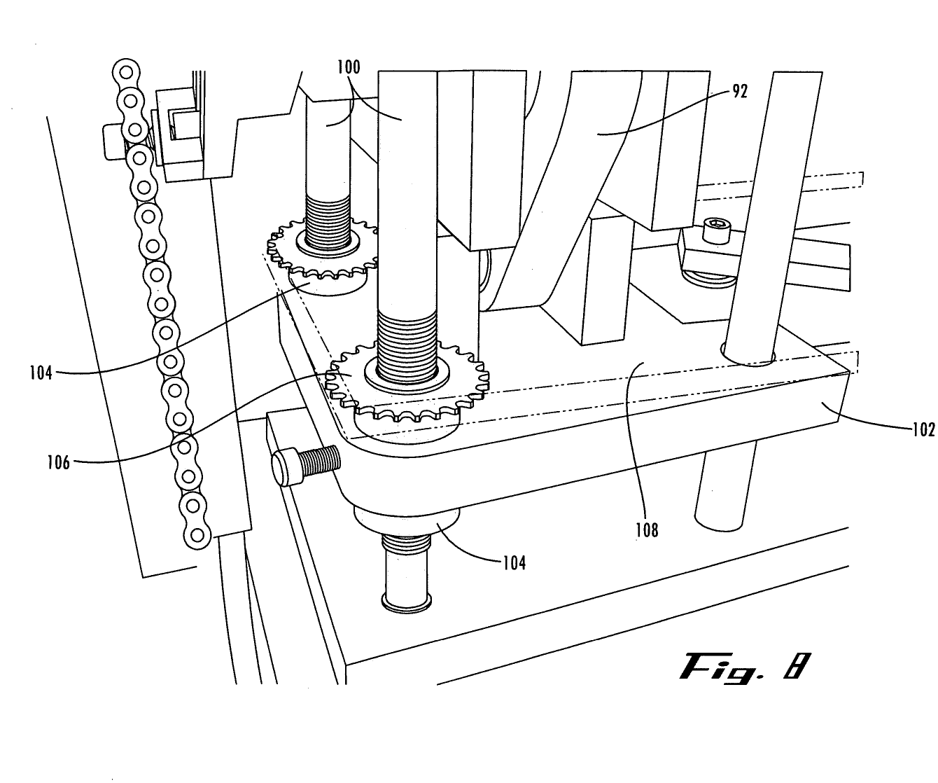

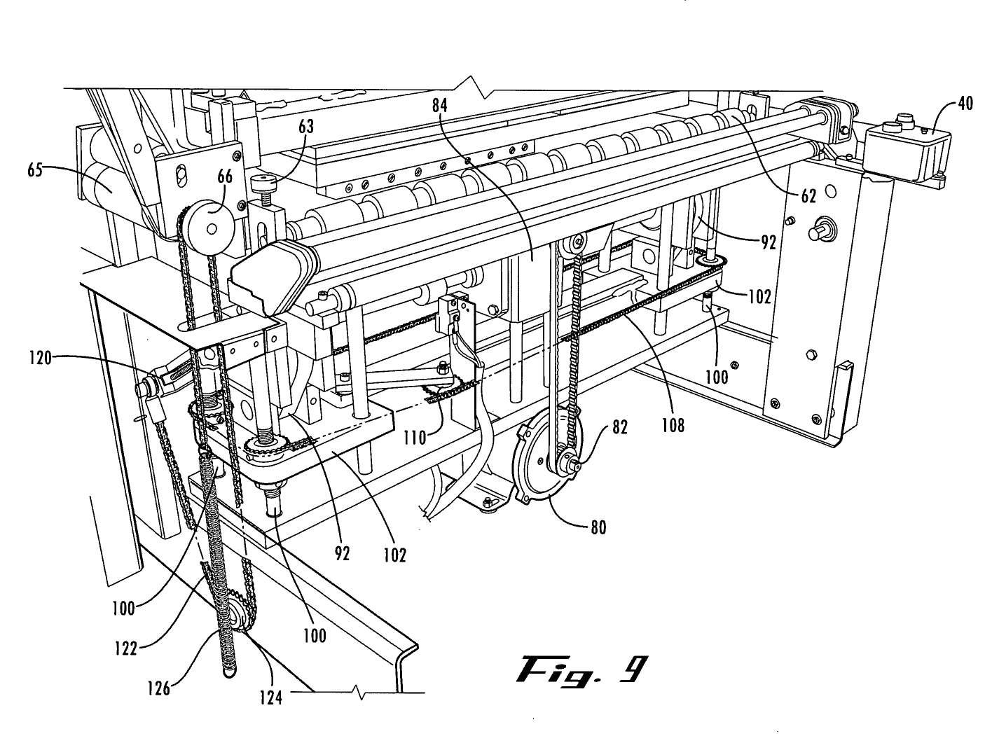

As the print head 50 is lowered onto the foil 30 and the paper stock 14, pressure is applied by the print head to emboss the foil onto the paper stock. Depending on the application required and a variety of factors, the pressure needed to emboss the foil 30 onto the paper stock 14 can vary significantly. Such factors include the thickness of the paper stock 14, the thickness of the foil 30, the number of chases 54, the length of the slugs 52, etc. In example embodiments, the amount of pressure applied by the print head 50 can be manually or automatically varied as desired by a user to meet the needs of a particular print cycle. As shown in FIG. 8, each sub-platform 102 adjustably receives a threaded vertical post 100 therein. In preferred forms, the threaded vertical posts 100 are received by threaded vertical sleeves 104, wherein the posts can be adjusted vertically in relation to the platform 102. A locking bolt 105 can be tightened against one or more posts 100 to restrict unwanted vertical adjustments. In order to ensure that each post 100 is equally adjusted, and thereby ensure that the print head 50 applies equal pressure across its length when applied to the foil 30 and paper stock 14, each threaded vertical sleeve 104 is fitted with a toothed gear 106, and each gear is linked together with a chain or belt 108 as best seen in FIG. 9. In this manner, vertical adjustment of any one post 100 simultaneously adjusts the other posts, via an interlinking chain or belt 108, such that each post is equally aligned vertically in relation to the platforms 102. An adjustable tension regulator 110 is preferably provided for maintaining proper tension within the belt or chain 108.

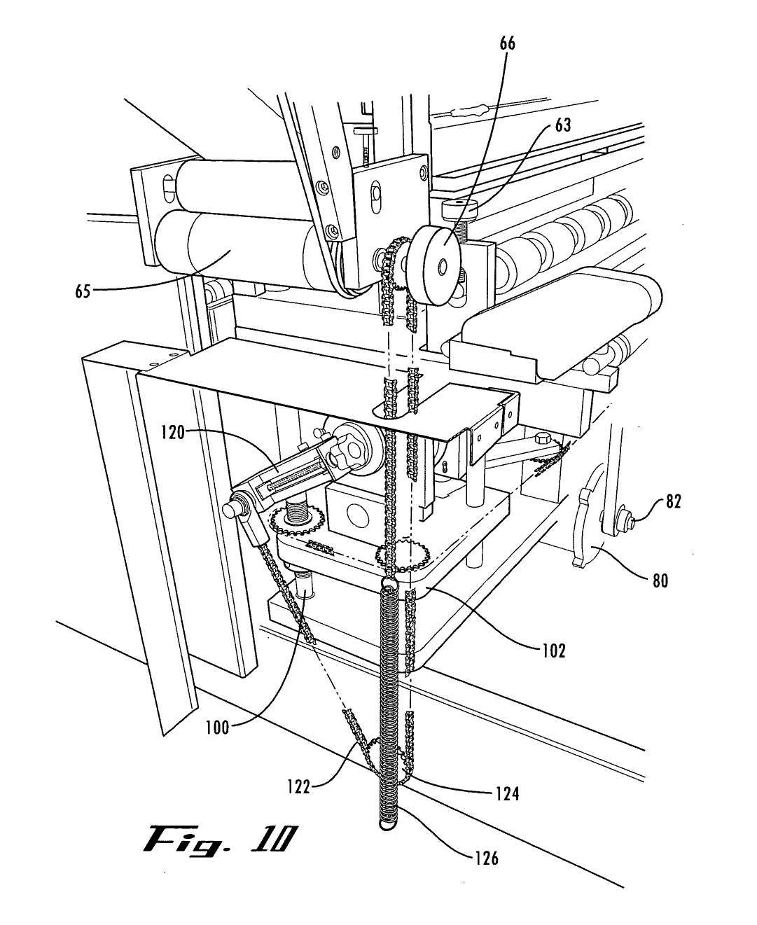

The foil 30 is advanced by a foil advancement mechanism, which is preferably also driven by the electric motor 80. For example, the cam shaft 90 is preferably coupled by gearing or other transmission means to drive the foil advancement mechanism, such as with a chain or belt drive mechanism, as shown in FIGS. 9-10. In preferred forms, the cam shaft 90 is connected to an adjustable length rotatable arm 120. The arm 120 is preferably linked with a foil advancement drum 65 through a series of at least one chain 122, at least one gear 124, and a spring 126. A ratchet-like handle 66 adapted to receive the chain 122 is operated by the cyclical pivotal motion of the arm 120. A ratcheting handle 66 turns in only one direction, such that for each full rotation of the rotatable arm 120, the handle rotates for only half of the corresponding arm rotation. Each successive rotation by the handle 66 engages the foil advancement drum 65 and advances the foil 30 in sequential increments. The amount of foil 30 pulled per stroke of the arm 120 varies with the length of the arm, such that as the length of the arm is increased, so does the length of foil advanced per rotation. The arm's length can be adjusted manually or automatically to increase or decrease the amount of foil 30 advanced per rotation as desired by a user.

The paper stock advancement mechanism 60 preferably uses a transmission means similar to that of the foil advancement mechanism to incrementally advance the paper stock 14 through the apparatus 10. For example, in preferred forms the paper stock advancement mechanism is also driven by the electric motor 80. The cam shaft 90 is fitted with at least one gear or rotatable arm at a distal end of the shaft in relation to the foil advancement mechanism. The rotatable arm is chain-linked to the paper stock advancement mechanism 60, which has a ratcheting gear attached thereto, and to a spring. Similarly to the foil advancement mechanism, the ratcheting gear only turns in one direction such that each stroke of the rotatable arm, or revolution of the at least one gear, turns the ratcheting gear for half of the corresponding arm or gear rotation, thereby rotating in increments. Preferably, the paper advancement mechanism 60 is actuated when the print head is raised, and terminated when the print head is lowered.

As the paper advancement mechanism 60 is incrementally rotated, the rollers 62 frictionally engage and advance the imprinted gift-wrap 12 towards the take-up-roll 22, and advance fresh paper stock 14 beneath the print head 50. The amount of pressure applied by the paper stock advancement mechanism can be made adjustable with locking bolts 63 depending on the necessary friction required for the rollers 62 to advance the paper stock 14. To adjust the amount of paper stock 14 that is advanced through the apparatus 10 for each print head cycle, the radius of the rotatable arm, or gear, can be adjusted. To increase the amount of paper stock 14 advanced through the apparatus 10 for each print head cycle, the radius of the rotatable arm, or gear, must be increased. Similarly, to decrease the amount of paper stock 14 advanced for each print head cycle, the radius must be decreased.

The invention also includes a method of personalizing gift-wrap. Interchangeable printing slugs 52 are preferably loaded into a reusable print head 50 of a printing apparatus 10. The slugs 52 preferably include impression faces in the form of lettering, forming one or more words, to impart a personalized textual message onto the paper stock 14 to be personalized, upon operation of the printing apparatus 10 as described above. In further embodiments of the method, printing slugs 52 are pre-configured with one or more standard personalized message portions, such as “Happy Birthday {name}”, wherein only the “{name}” portion of the message needs to be custom-configured for each print run.

The invention also includes a personalized gift-wrap 12. For example, a decorative gift-wrap paper stock 14 is imprinted with a personalized message in metallic printing foil 30 or other printing medium. The message may include the name or other identifying characteristics of a specific person, and/or a particular event or date, such as a person's birthday, anniversary, retirement, or the like.

While the invention has been described with reference to preferred and example embodiments, it will be understood by those skilled in the art that a variety of modifications, additions and deletions are within the scope of the invention, as defined by the following claims.

What is claimed is:

1. An apparatus for printing personalized gift-wrap, said apparatus comprising
an electric motor;
a print head actuated by the electric motor for motion between a raised position and a lowered position, said print head comprising at least one receiver chase for releasable engagement of an interchangeable printing slug for printing a personalized message;
a paper stock advancement mechanism driven by the electric motor to advance a paper stock from a paper feed roll to a paper take-up roll, said paper stock advancement mechanism advancing the paper stock in step-wise increments in sequence with the motion of the print head; and
a printing foil advancement mechanism driven by the electric motor to advance a printing foil from a foil feed roll to a foil take-up roll, said printing foil advancement mechanism advancing the printing foil in step-wise increments in sequence with the motion of the print head.

2. The apparatus of claim 1, wherein the print head comprises a plurality of receiver chases for releasable engagement of interchangeable printing slugs for printing a personalized message.

3. The apparatus of claim 2, wherein each of the plurality of receiver chases is laterally offset from an adjacent receiver chase.

4. The apparatus of claim 1, wherein the personalized message includes an individual's name.

5. The apparatus of claim 1, wherein the personalized message includes a symbol.

6. The apparatus of claim 1, wherein the personalized message includes an event of particularized significance to an individual.

7. The apparatus of claim 1, wherein the print head is heated.

8. The apparatus of claim 1, wherein the print head comprises at least one spring-biased bearing for engagement of the interchangeable printing slug within the at least one receiver chase.

9. The apparatus of claim 1, further comprising a cutting blade movable along a paper cutting bar adjacent the paper take-up roll.

10. The apparatus of claim 1, further comprising a cam-actuated drive mechanism linking the electric motor to the print head.

11. The apparatus of claim 10, further comprising a pressure adjustment linkage for varying a stroke of the print head in response to operation of the cam-actuated drive mechanism.

12. The apparatus of claim 1, further comprising a gearbox driving a first driveshaft coupled to the paper stock advancement mechanism, and a second driveshaft coupled to the printing foil advancement mechanism.

13. The apparatus of claim 12, wherein at least one of the first and second driveshafts has a cam mounted thereon for raising and lowering the print head.

14. The apparatus of claim 1, wherein the printing foil advancement mechanism comprises a first adjustable length rocker arm coupled by a first flexible drive linkage to a first ratcheting member in operative engagement with the foil take-up roll.

15. The apparatus of claim 1, wherein the paper stock advancement mechanism comprises a second adjustable length rocker arm coupled by a second flexible drive linkage to a second ratcheting member in operative engagement with the paper take-up roll.

16. A printing apparatus having a first drive mechanism for transporting wrapping paper stock in a first direction, a second drive mechanism for transporting printing media over the paper stock, and a printing head for transferring a portion of the printing media onto the paper stock in the pattern of a personalized message.

17. The printing apparatus of claim 16, wherein the first drive mechanism, the second drive mechanism, and the printing head are all driven by a common motor.

18. The printing apparatus of claim 16, wherein the print head comprises a plurality of receiver chases for releasable engagement of interchangeable printing slugs for printing the personalized message.

19. The apparatus of claim 18, wherein each of the plurality of receiver chases is laterally offset from an adjacent receiver chase.

20. A method of personalizing gift-wrap, comprising:
installing an interchangeable print slug into a print head of a printing apparatus, the interchangeable print slug comprising an impression face in the pattern of a message having particularized significance to an individual; and
operating the printing apparatus to print the message having particularized significance to an individual onto paper stock suitable for gift-wrapping.

21. A personalized gift-wrap product, comprising:
a paper stock suitable for use as gift wrapping; and
a message transfer-printed onto said paper stock, said message having particularized significance to an individual.
